(19) United States
(12) Patent Application Publication
(10) Pub. No.: US 2025/0021681 A1
(43) Pub. Date: Jan. 16, 2025

(54) BROKER SYSTEM FOR PROVIDING EXECUTABLE PROGRAM CODE

(71) Applicant: nth degree llc, Westminster, CO (US)

(72) Inventor: Paul Stout, Denver, CO (US)

(21) Appl. No.: 18/617,357

(22) Filed: Mar. 26, 2024

Related U.S. Application Data
(60) Provisional application No. 63/513,879, filed on Jul. 15, 2023.

(51) Int. Cl. G06F 21/62

(52) U.S. Cl. CPC G06F 21/6218

(57) ABSTRACT

A broker system may generate one or more queries for upstream systems based on a request received from the secure client executing on the computing system. A broker system may transmit the one or more queries to the upstream systems. A broker system may receive information from the upstream systems responsive to transmitting the one or more queries to the upstream systems, wherein the information includes at least in part executable program code received from at least one of the upstream systems. A broker system may generate a secure package including at least the executable program code. A broker system may transmit the secure package to the secure client, the executable program code being executable on the computing system by the secure client, wherein content of the secure package is inaccessible to the computing system outside of the secure client.

### RELATED APPLICATIONS

The present application claims priority to U.S. Provisional Application No. 63/513,879, filed on Jul. 15, 2023, and entitled “Platform agnostic service access interface,” which is specifically incorporated by reference for all that it discloses and teaches.

### BACKGROUND

Many service providers provide some form of remote monitoring and management. More advanced service providers also offer some form of proactive response to conditions within their customer's environments. This functionality is generally provided through a specific, separate application or web portal. Conventional remote management platforms typically interact with a specific system to perform predefined requests.

For example, a conventional remote management platform may allow customers to query a particular system (e.g., a ticketing system) through advanced coding and create tickets through the same platform. However, such platforms require the customer to then log into that ticketing system to interact with the automatically created tickets. Such platforms also do not typically interact with systems dealing with other aspects of the customer relationship (e.g., accounting, and billing systems) outside of the particular system.

### SUMMARY

In some aspects, the techniques described herein relate to a method of providing a program code to a secure client executing on a computing system, including: generating one or more queries for upstream systems based on a request received from the secure client executing on the computing system; transmitting the one or more queries to the upstream systems; receiving information from the upstream systems responsive to transmitting the one or more queries to the upstream systems, wherein the information includes at least in part executable program code received from at least one of the upstream systems; generating a secure package including at least the executable program code; and transmitting the secure package to the secure client, the executable program code being executable on the computing system by the secure client, wherein content of the secure package is inaccessible to the computing system outside of the secure client.

In some aspects, the techniques described herein relate to a broker system for providing executable program code to a secure client, wherein the secure client is executable on a computing system, including: one or more hardware processors; a query generator executable by one or more hardware processors and configured to generates one or more queries for upstream systems based on a request received from the secure client executing on the computing system, transmit the one or more queries to the upstream systems; a communication interface executable by one or more hardware processors and configured to receive information from the upstream systems responsive to transmitting the one or more queries to the upstream systems, wherein the information includes at least in part executable program code received from at least one of the upstream systems; and a secure package generator executable by one or more hardware processors and configured to generate a secure package including at least the executable program code, the communication interface being further configured to transmit the secure package to the secure client, the executable program code being executable on the computing system by the secure client, wherein content of the secure package is inaccessible to the computing system outside of the secure client.

In some aspects, the techniques described herein relate to one or more tangible processor-readable storage media embodied with instructions for executing on one or more processors and circuits of a broker system a process for providing a program code to a client operating on a computing system, the process including: generating one or more queries for upstream systems based on a request received from a secure client executing on the computing system; transmitting the one or more queries to the upstream systems; receiving information from the upstream systems responsive to transmitting the one or more queries to the upstream systems, wherein the information includes at least in part executable program code received from at least one of the upstream systems; generating a secure package including at least the executable program code; and transmitting the secure package to the client, the executable program code being executable on the computing system by the secure client, wherein content of the secure package is inaccessible to the computing system outside of the secure client.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing environment for providing program code executable on a customer system responsive to receiving a request from the customer system.

FIG. 2 illustrates an example computing environment for providing, through querying to a plurality of service systems, program code executable on a customer system responsive to receiving a request from the customer system.

FIG. 3 illustrates an example computing environment for querying a plurality of service systems responsive to receiving a request from the customer system.

FIG. 4 illustrates an example computing environment for querying a plurality of service systems and providing computer-executable program code to a customer system responsive to a request received from the customer system.

FIG. 5 depicts an example method for providing executable code for a client to execute on a computing system.

FIG. 6 illustrates an example computing device for use in implementing the described technology.

### DETAILED DESCRIPTIONS

A major disadvantage to conventional remote management platforms is that multiple platforms are required for the customer to interact with multiple upstream systems. Such an approach does not provide a holistic solution to all aspects (e.g., service delivery, service visibility, customer engagement) of a customer relationship. Also, conventional platforms are limited to performing a set of predefined tasks involving a specific computing system. Such conventional platforms cannot provide satisfactory responses to requests that do not involve a limited set of predefined tasks.

Further, when providing platform-specific solutions, service providers often must disclose specific code and methods to the customer that service providers would prefer to keep as confidential trade secret information. To protect these secrets, service providers may use lower-level programming languages (e.g., programming language C), but some target platforms do not support programs generated through such strategies. For instance, the vendor may reject these submissions because it cannot inspect the code to determine the suitability and security of that code.

The technology disclosed herein addresses these inadequacies by providing for a broker system that can, responsive to receiving a customer request, generate backend API calls with multiple upstream systems and then transform, sanitize, augment, and/or enrich the raw data from the backend API before presenting it back to the customer as an executable program code. For example, responsive to receiving a customer request, the broker system can interact with and query multiple systems for information necessary to compile or otherwise generate the executable program code to perform a process responsive to the customer request. In some instances, the technology disclosed herein, after receiving information from one or more upstream systems responsive to an initial set of queries, can generate a further set of queries to obtain further information from the upstream systems for compiling or otherwise generating the executable program code. For example, the broker system can receive a secure-client-initiated request to perform a process, query a first upstream system to receive initial information, and query a second upstream system using the initial information to receive executable program code from the second upstream system that the broker system can provide to the secure client. The intelligent, dynamic querying in the technology described herein improves responses provided to customer queries over responses provided by conventional remote management platforms that operate according to rigid, predefined query flows.

The broker system provided in the described technology enables an operator of the customer system to interact with any aspect of a service provider's service (e.g., ticketing, account management, billing, environment monitoring, scheduling, escalations systems, etc.) through a unified, normalized, and predictable framework that saves time and resources for both the customer and the service providers. The broker system enables servicing of advanced account questions not visualized by other platforms and also enables optimization of service usage based on actual, observed consumption, and by efficiency gained through repeatable processes.

The described technology also provides advantages to service providers that are not realized by conventional remote management platforms. The broker system of the described technology can intelligently identify problems/issues of the customer system and generate queries to multiple upstream systems to obtain or otherwise generate program code that can be executed on the customer system to address the problems/issues of the customer system. Also, the broker system provides a single platform that can interface with backend technology of multiple service providers while conventional remote management requires a separate remote management platform for each service provider/technology. The broker system provides a single interface for interacting with various service systems (e.g., accounting, billing, service, monitoring, and reporting systems), even though all of those functions may be provided by radically different backend systems. Accordingly, the described technology only requires customer system operators to learn how to interact with a single broker system while, in conventional remote management, customers need to learn how to operate separate remote management platforms to interact with multiple service systems.

In some instances, the broker system receives a request from a secure client (e.g., a secure application) executing on a customer system. The broker system generates at least one query for at least one upstream system based on the request received from the secure client executing on the customer system. The broker system receives information from the at least one upstream system responsive to transmitting the at least one query. The broker system determines program code based at least in part on the information received from the at least one upstream system. In some instances, at least part of the information received from the upstream systems includes program code. In some instances, the broker system generates the program code based at least in part on the received information. In some instances, the broker system generates a combined program code based on program code received from each of multiple upstream systems. The broker system transmits the program code to the secure client. The program code is executable by the customer system to perform a process that is requested in the initial request provided by the secure client to the broker system or to perform a process that addresses an issue identified in the initial request provided by the secure client.

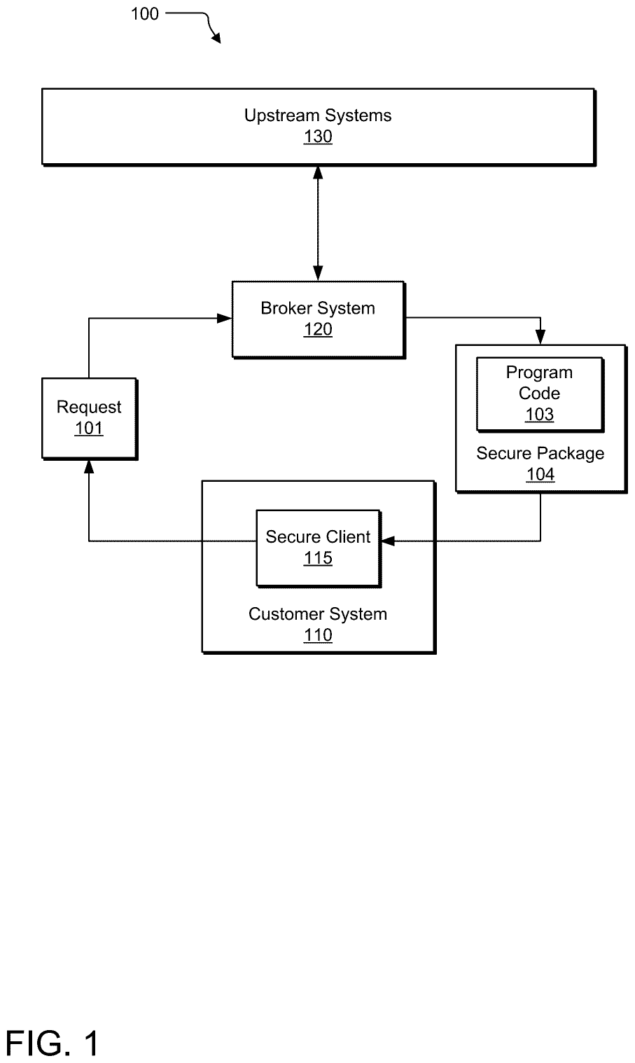

FIG. 1 illustrates an example computing environment 100 for providing program code executable on a customer system responsive to receiving a request from the customer system. Aspects of the computing environment 100 not specifically described with respect to FIG. 1 may be the same or similar to other implementations described herein.

The example computing environment 100 includes a customer system 110, a broker system 120, and upstream systems 130. The broker system 120 communicates with the upstream systems 130 via one or more networks and also communicates with customer system 110 via a network. Specifically, the broker system 120 communicates with a secure client 115 executing on the customer system 110.

The secure client 115 provides a dashboard for an operator of the customer system 110 to interact with the broker system 120, for example, by entering requests 101 and receiving responsive information (e.g., program code 103) from the broker system 120 responsive to the requests. For example, the secure client 115 is a secure application that operates on the customer system 110. The customer system 110 includes a user interface and the secure client 115 can receive one or more inputs from the operator entered via the user interface.

The broker system 120 can receive a request 101 from the secure client 115 executing on the customer system 110. In some instances, the request 101 can be a natural language query entered by an operator of the customer system 110 via the secure client 115. In some instances, the request 101 can be generated from one or more selections of objects on a user interface (e.g., selections via predefined or dynamically populated drop-down menus) provided by the secure client 115 on the customer system 110. Other formats for the request 101 include direct programmatic input or direct Java-script object notation (JSON) input. In some instances, the secure client 115 can generate the direct programmatic input or JSON input responsive to a user selection of a link on a user interface of the customer system 110. In some instances, the secure client 115 generates the request 101 based on the results of a previous request. In some instances, the request can identify a process that an operator of the customer system 110 wishes to perform on the customer system 110. For example, the request 101 states “Please run a health check” or the request 101 defined by selected objects on the user interface include a selection of “health check” from a drop-down menu. In some instances, the request 101 can identify a problem or other issue that the operator of the customer system 110 needs the broker system 120 to address. The broker system 120 can provide, to the secure client 115 responsive to receiving the request 101, program code 103. The customer system 110 can execute the program code 103 to perform a process that addresses an issue, problem, requested action, or other content of the request 101.

As depicted in FIG. 1, the broker system 120 communicates with upstream systems 130. The upstream systems 130 can be service provider systems that provide various services to the customer system 110 and to the broker system 120. Examples of upstream systems 130 can include but are not limited to systems for service engagement (e.g., providing tickets, service requests), systems for service utilization (e.g., services used vs. services paid for), systems for service efficacy (e.g., how well customer technology works over time using services), and systems for proactive service engagement (e.g., identifying and/or resolving customer problems/issues before the customer reports them). In some implementations, the systems for proactive engagement requests customer approval for resolving any customer problems/issues after reporting the identified customer problem/issue to the customer via the secure client 115. In some implementations, one or more of the upstream systems 130 are subsystems of the broker system 120.

The broker system 120 can transmit one or more queries to the upstream systems 130 and receive information responsive to the queries from the upstream systems 130. The broker system 120 generates the one or more queries for the upstream systems 130 based on the request 101 received from the secure client 115 executing on the customer system 110. In some instances, the broker system 120 identifies, in the request 101, a process for which an operator of the customer system 110 requested program code 103 that is executable by the customer system 110 for performing the process. The broker system 120 generates a set of queries to the upstream systems 130 for receiving, accessing, obtaining, or otherwise generating the program code 103 executable on the customer system 110 for performing the process. In some instances, the request 101 does not identify a process but identifies a problem and the broker system 120 generates one or more queries to upstream systems 130 to identify a process for addressing the problem and to receive, access, obtain, or otherwise generate the program code 103. In some instances, the user of the customer system 110 generates a request 101 via the secure client 115 (e.g., using dropdown menus to identify an issue, select a date/time, and schedule the request 101). In some instances, the secure client 115 identifies a type associated with the request and retrieves a set of information needed for processing the type associated with the request 101, determines that more information is needed by comparing information received in/with the request 101 to the retrieved set of information, requests further information from the user (e.g., via the user interface of the customer system 110), and may collect the further information upon the user providing the information. In some instances, the broker system 120 generates a query that includes the request 101 and forwards the query to an analysis system with a request for the information needed to process the request 101. The analysis system responds to the query with a set of queries to send to one or more upstream systems to obtain at least a portion of the further information and, in some instances, a set of queries for the user on the customer system 110 to obtain at least a portion of the further information. In some instances, the broker system 120 compares keywords in the request 101 to keywords associated with one or more predefined queries and selects a set of queries from the among predefined queries having the highest similarity to the request based on a number of matching keywords. In some instances, the broker system applies a machine learning model to the request 101 to generate the set of queries.

The broker system 120, in some instances, may identify the upstream systems 130 from which the broker system 120 needs information to generate, receive, or otherwise provide the program code 103 to the secure client 115 executing on the customer system 110. The broker system 120 may generate multiple queries to the upstream systems 130 to obtain the information. In some instances, the broker system 120 receives the program code 103 from the upstream systems 130 (e.g., from a singular upstream system or portions of program code 103 from each of multiple upstream systems) responsive to querying the upstream systems 130. In some instances, the broker system 120 generates at least a portion of the program code 103 responsive to information received from the upstream systems 130.

The broker system 120 provides the program code 103 to the secure client 115. For example, the broker system 120 generates a secure package 104 that includes the program code 103 and transmits the secure package 104 to the secure client 115. The contents of the secure package 104 (e.g., including the program code 103) are not accessible to the customer system 110 outside of the secure client. The secure client 115 executes the program code 103 on the customer system 110 to perform a process that is responsive to the request 101. In some implementations, the secure client 115 displays a response to the request 101 via a user interface of the customer system 110. The response indicates that the program code 103 has been generated and requests approval by an operator of the customer system 110 to execute the program code 103 to perform the process. The secure client 115, in some implementations, does not reveal or otherwise provide access to program code 103 for the customer system 110. For example, information received by the broker system 120 from upstream systems 130 (e.g., portions of the program code 103) may include sensitive data or internal (e.g., trade secret) data that the secure client 115 is not allowed to expose to customer system 110 and to operators of the customer system 110. In some implementations, the secure client 115 does not store the program code 103 on the customer system 110 and deletes the program code 103 if an approval to execute the program code 103 is not received from the operator of the customer system 110 within a threshold length of time.

The secure client 115 may display an overview of the process to be performed when the program code 103 is scheduled to be executed on the customer system 110 and a request to approve the scheduling of the execution of the program code 103 on the customer system 110. Responsive to receiving an input from the operator of the customer system 110 via the user interface approving the of scheduling of the execution of the program code 103, the secure client 115 executes, at a time associated with the scheduling, the program code 103 on the customer system 110 to perform the process. For example, the process is a customer system 110 health check and the secure client 115 executes the program code 103 to perform the health check of the customer system 110. In some implementations (e.g., where executing the program code 103 involves adding or removing content that requires authorization), the execution of the program code 103 is on demand and the secure client 115 can display a request to execute the program code 103 on the customer system 110 and execute the program code 103 upon receiving an approval of the request from the customer system 110 (e.g., the user approves the request by actuating an object on a user interface of the customer system 110).

In some implementations, an operator of the customer system 110 can access the broker system 120 via a portal platform of the customer system 110 that communicates with the broker system 120 via a network. In these implementations, the operator provides multifactor authentication (e.g., two-factor or three-factor authentication) to access the broker system 120 via the portal and the network. For example, three-factor authentication requires something the operator knows (e.g., a password), something the operator has (e.g., a code received on a mobile device to prove possession of the mobile device, a signed certificate, a physical token, an access credential such as an SSH key, etc.), and something the operator is (e.g., verification of a physical or logical location, verification of facial features, a retinal scan, a fingerprint or other biometrics, etc.). In some implementations, using the portal platform, the operator of the customer system 110 can initiate automated outcomes across platforms (e.g., upstream systems 130) shaping the executable program code 103. Outside that, the operator can update security credentials, download customer-specific secure clients (e.g., secure client 115), interact with the ticketing system, add/remove contacts, update security credentials, and review the status of agreements or other relationship parameters.

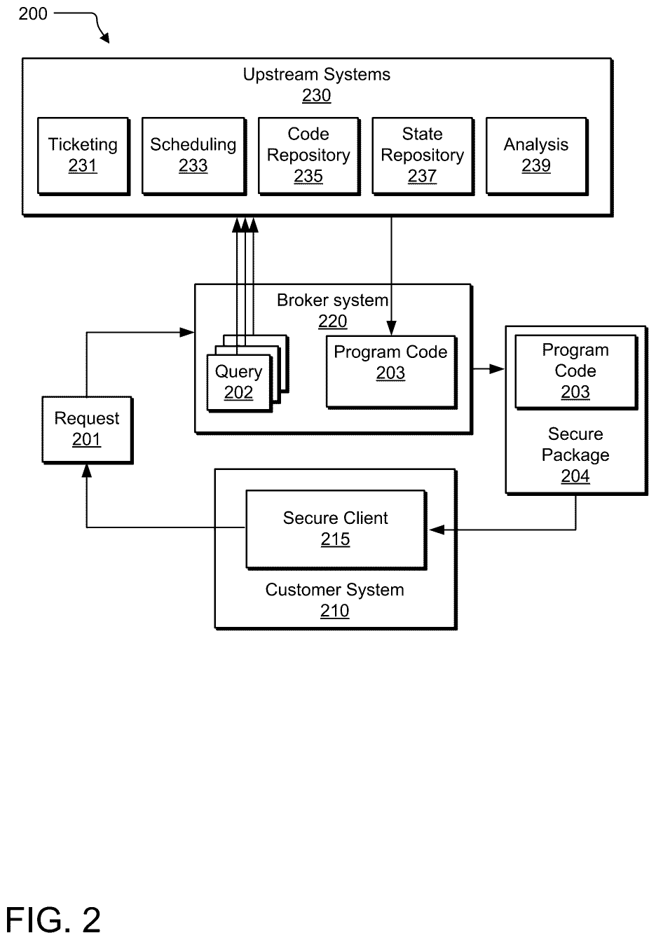

FIG. 2 illustrates an example computing environment 200 for providing, through querying to a plurality of service systems, program code executable on a customer system responsive to receiving a request from the customer system. Aspects of the computing environment 200 not specifically described with respect to FIG. 2 may be the same or similar to other implementations described herein.

The example computing environment 200 includes a customer system 210, a broker system 220, and upstream systems 230. The broker system 220 communicates with the upstream systems 230 via one or more networks and also communicates with customer system 210 via a network. Specifically, the broker system 220 communicates with a secure client 215 executing on the customer system 210.

The broker system 120 receives a request 201 from the secure client 215 executing on the customer system 210. The broker system 220 can provide, to the secure client 215 responsive to receiving the request 201, program code 203. The customer system 210 can execute the program code 203 to perform a process that addresses an issue, problem, requested action, or other content of the request 201.

As depicted in FIG. 2, the broker system 220 communicates with upstream systems 130. The upstream systems 230 can be service provider systems that provide various services to the customer system 210 and to the broker system 220. In the example depicted in FIG. 2, the upstream systems 230) include ticketing 231, scheduling 233, code repository 235, state repository 237, and analysis 239 systems. For example, ticketing 231 is a system that assigns a ticket (e.g., an identifier) to a process and updates the ticket with status information as the process is performed. For example, scheduling 233 is a system that generates a schedule or set of requests for performing various steps of a process. For example, code repository 235 is a system that stores program code that can be used to perform a variety of processes when executed by customer systems (e.g., customer system 210). For example, state repository 237 is a system that manages and stores system and application settings for various customer systems (e.g., customer system 210). For example, analysis 239 is a system that can receive the request originating from the customer system 110 from the broker system 120 and can provide information to the broker system 120 for generating queries to various other upstream systems. Upstream systems could further include a customer's ticketing system, a customer's inventory control system, a customer's change control system, a customer's password/secret management system, a customer's application store (e.g., application repository). The particular upstream systems 230 depicted in FIG. 2 are examples and the computing environment 200 can include additional and/or alternative upstream systems than the example upstream systems 230 depicted in FIG. 2.

The broker system 220 can transmit queries (e.g., query 202) to the upstream systems 230 and receive information responsive to the queries from the upstream systems 230 based on the request 101 received from the secure client 215. The broker system 220, in some instances, may identify particular upstream systems 230 from which the broker system 220) needs information to generate, receive, or otherwise provide the program code 203 to the secure client 215 executing on the customer system 210. The broker system 220 may generate, as depicted in FIG. 2 via multiple arrows, multiple queries (e.g., including query 202) to the particular upstream systems 230 to obtain the information including the program code 203. For instance, the broker system 220 may generate a query for the first portion of the program code 203 from a first upstream system and generate a query for a second portion of the program code 203 from a second upstream system, and so forth. In another example, the broker system may generate a query to a first upstream system (e.g., an analysis system) for preliminary information (e.g., configuration information, system identifiers, etc.) that is needed for generating a subsequent query to a second upstream system for the program code 203.

The broker system 220 provides the program code 203 to the secure client 115. For example, the broker system 220 generates a secure package 204 that includes the program code 203 and transmits the secure package 204 to the secure client 115. The contents of the secure package 204 (e.g., including the program code 203) are not accessible to the customer system 210 outside of the secure client. The secure client 215 executes the program code 203 on the customer system 210 to perform a process that is responsive to the request 201. The secure client 215, in some implementations, does not reveal or otherwise provide access to program code 203 for the customer system 210. For example, the program code 203 and other contents of the secure package 204 are inaccessible to the customer system 210 outside of the secure client 215. In some implementations, the secure client 215 does not store the program code 203 on the customer system 210 and deletes the program code 203 if an approval to execute the program code 203 is not received from the operator of the customer system 210 within a threshold length of time. Responsive to receiving an input from the operator of the customer system 210 via the user interface approving the execution of the program code 203, the secure client 215 executes the program code 203 on the customer system 210 to perform the process. For example, the process is a customer system 210 health check and the secure client 215 executes the program code 203 to perform the health check of the customer system 210.

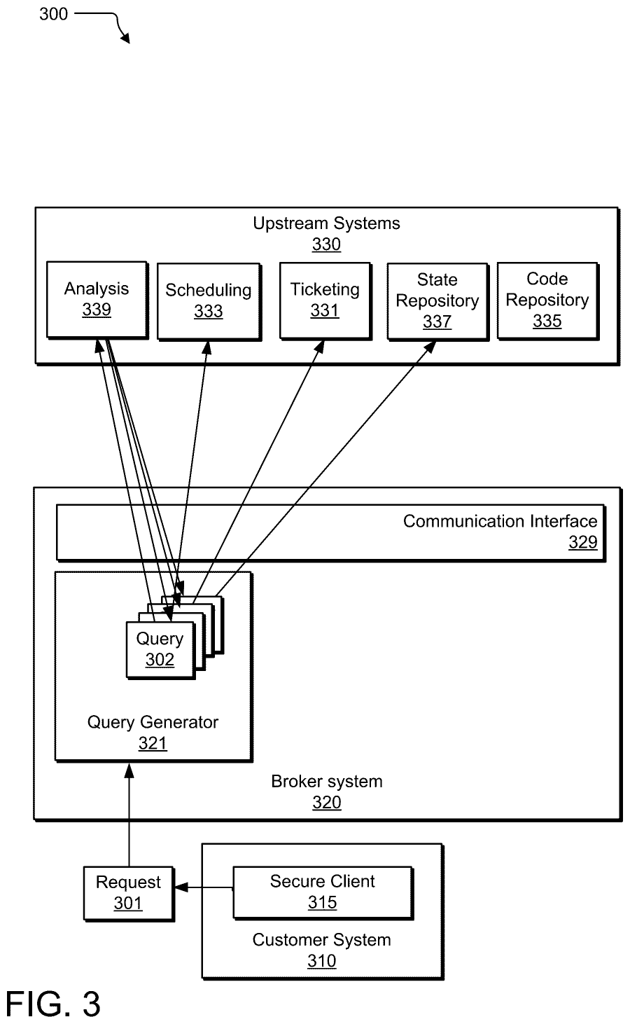

FIG. 3 illustrates an example computing environment 300 for querying a plurality of service systems responsive to receiving a request from the customer system. Aspects of the computing environment 300 not specifically described with respect to FIG. 3 may be the same or similar to other implementations described herein.

The example computing environment 300 includes a customer system 310, a broker system 320, and upstream systems 330. The broker system 320 communicates with the upstream systems 330 via a communication interface 329 one or more networks and also communicates with customer system 310 via a network. The broker system 320 communicates, via the communication interface 329 and a network, with a secure client 315 executing on the customer system 310. The broker system 320 receives a request 301 from the secure client 315 executing on the customer system 310. The broker system 320 can provide, to the secure client 315 responsive to receiving the request 301, program code 303. The customer system 310 can execute the program code 303 to perform a process that addresses an issue, problem, requested action, or other content of the request 301.

As depicted in FIG. 3, the broker system 320 communicates with upstream systems 330. The example upstream systems 330 include ticketing 331, scheduling 333, code repository 335, state repository 337, and analysis 339 systems. The particular upstream systems 330 depicted in FIG. 3 are examples and the computing environment 300 can include additional and/or alternative upstream systems than the example upstream systems 330) depicted in FIG. 3. The broker system 320 can transmit queries (e.g., query 302) to the upstream systems 330 and receive information responsive to the queries from the upstream systems 330 based on the request 301 received from the secure client 315. The broker system 320 may generate, as depicted in FIG. 3, an initial query 302 to the analysis 339 upstream system and receive, as indicated via multiple arrows in FIG. 3, multiple suggested queries for transmitting to particular upstream systems 330 to obtain further information. For instance, the broker system 320 may receive, from the analysis 339 upstream system, suggested queries that, as indicated in FIG. 3, the query generator 321 then transmits to the particular upstream systems 330. For example, the query generator 321 transmits the suggested queries received from the analysis 339 upstream system to the scheduling 333, ticketing 331, and state repository 337 upstream systems.

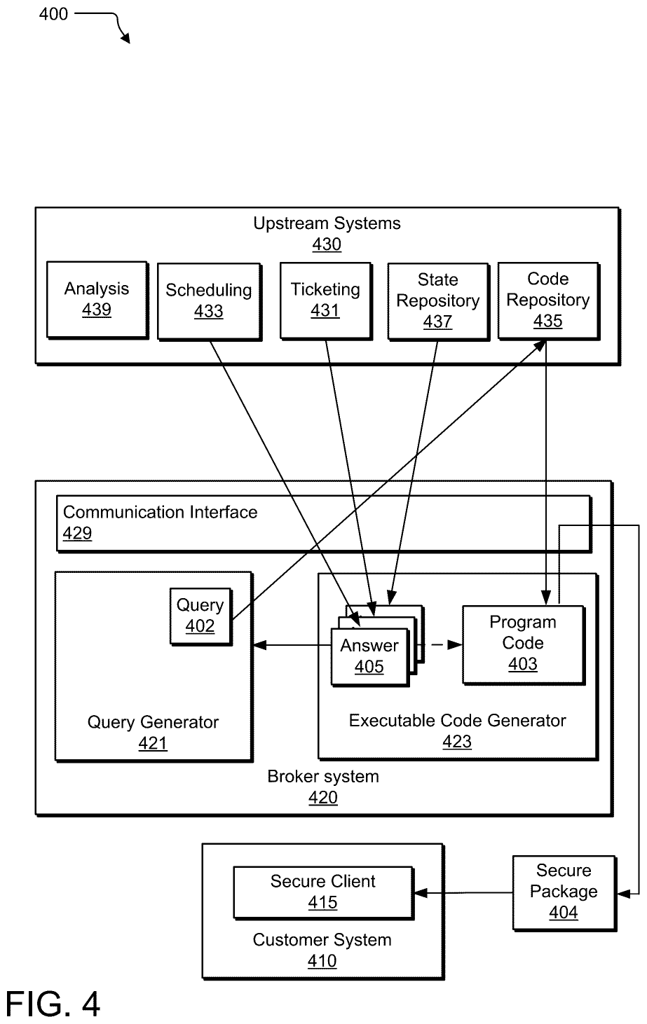

FIG. 4 illustrates an example computing environment 400 for querying a plurality of service systems and providing computer-executable program code to a customer system responsive to a request received from the customer system. Aspects of the computing environment 400 not specifically described with respect to FIG. 4 may be the same or similar to other implementations described herein.

The example computing environment 400 includes a customer system 410, a broker system 420, and upstream systems 430. The broker system 420 communicates with the upstream systems 430 via a communication interface 429 and one or more networks and also communicates with customer system 410 via a network. The broker system 420 communicates, via the communication interface 429 and a network, with a secure client 415 executing on the customer system 410. In some implementations, the components of FIG. 4 are similar to like components described in FIG. 3 and the example processes/flow that occur in FIG. 4 take place after the processes/flow described previously in FIG. 3.

As depicted in the example of FIG. 4, the executable code generator 423 receives answers (e.g., answer 405) from each of the queried upstream systems 430 (e.g., scheduling 433, ticketing 431, code repository 435, analysis 439, and state repository 437 upstream systems) that are responsive to their respective queries (e.g. the queries depicted in FIG. 3). The query generator, in some implementations and as depicted in FIG. 4, can generate a further query to the code repository 435 system based on one or more of the answers (e.g., including answer 405) received from the queried upstream systems. For example, an answer (e.g., answer 405) from the state repository 437 upstream system can include an identifier associated with a program code 403, an answer from the scheduling 433 upstream system can include an identifier for the code repository 435, and an answer from the ticketing 431 upstream system can include a ticket number. In some instances, one or more answers (e.g., answer 405) received from one or more upstream systems by the executable code generator 423 can be provided to the query generator 421 and the query generator can generate one or more further queries (e.g., query 402) for one or more upstream systems 430 based on the one or more answers. For example, the query generator 421 transmits a query 402 to the code repository 435 system associated with the code repository 435 identifier that includes the identifier for the program code 403 received previously in the answer 405. The executable code generator 423 receives the program code 403 from the code repository 435 responsive to the query 402.

The broker system 420 acts as a broker for downstream API calls and can function as an aggregator for calls to upstream systems 430 of varying cardinality. In another example, an operator of the customer system 410 requests, via the secure client 415 through a request to create a new ticket (e.g., registering a complaint/problem with a service system). The primary upstream system would be the ticketing 431 system. However, the broker system 420 can query several different upstream systems 430 to determine the cause of the conditions that resulted in the customer wanting to create the ticket. Perhaps a specific customer system is under maintenance, has been deprecated, or is not a production system. The broker system 420 can determine the cause by querying various upstream systems 430 and obtaining information responsive to the queries. The broker system 420 can then intelligently block the ticket or alter the priority, informing the operator of the consumer system 410, based on real-time data about the assets the ticket references. This sets better expectations for the customer and reduces waste for the service provider.

In some instances, the executable code generator 423 modifies the program code 403 received from one or more of the upstream systems 430. For example, the executable code generator 423 could insert code to alert, using the ticket identifier, the ticketing 431 system when the client executes the program code 403.

The broker system 420 provides the program code 403 to the secure client 415. For example, the broker system 420 generates a secure package 404 that includes the program code 403 and transmits the secure package 404 to the secure client 415. The contents of the secure package 404 (e.g., including the program code 403) are not accessible to the customer system 410 outside of the secure client 415. The secure client 415 executes the program code 403 on the customer system 410 to perform a process that is responsive to the request (e.g., to the request 301 described in FIG. 3). The secure client 415, in some implementations, does not reveal or otherwise provide access to program code 403 for the customer system 410. For example, the program code 403 and other contents of the secure package 404 are only present in transient memory of the secure client 415 and are inaccessible to the customer system 410 outside of the secure client 415. For example, the program code 403 is not in its completed format in the transient memory. For example, the program code 403 in the transient memory may be a function of key values and variables. Accordingly, even if accessed in the transient memory, the program code 403 would not be intelligible and therefore is inaccessible in its completed, executable form to the customer system 410. In some implementations, program code 403 and other contents of the secure package 404 are stored in a trusted execution environment (TEE) and the TEE is only accessible to the secure client 415 and is inaccessible to the customer system 410. In these implementations, the secure client 415 removes the program code 403 from the TEE if an approval to execute the program code 403 is not received from the operator of the customer system 410 within a threshold length of time. Responsive to receiving an input from the operator of the customer system 410 via the user interface approving the scheduling of the execution of the program code 403, the secure client 415 schedules an execution of the program code 403 on the customer system 410 to perform the process. For example, the process is a customer system 410 health check and the secure client 415 executes, at a time associated with the scheduling, the program code 403 to perform the health check of the customer system 410. Executing the program code 403 involves, in some implementations, accessing the program code 403 in the transient memory. In some instances, the program code 403 in the transient memory is a function of key values and temporal variables and therefore the program code 403 accessed for execution may vary depending on the time it is accessed.

In an example, the broker system 420/320 receives a request 301 for a health check from the customer system 410/310 and forwards the request 301 to the analysis system 439/339. The analysis system 439/339 logs firewall events. The analysis system 439/339 generates a set of queries (e.g., including query 302) for the broker system 420 that can be used by the broker system 420 to obtain executable program code 403 that will resolve these firewall events, which are scheduled in a different time zone (e.g., Mountain Standard Time) from a time zone of the customer system 110 (e.g., Eastern Standard Time). As part of the set of queries generated by the analysis system 439/339, at least one query (e.g., query 302) includes a query that the broker system 420 will submit to the scheduling system 433/333 that will obtain information to resolve an offset between the different time zones for the scheduled firewall events. This obtained information can then be submitted in a query 402 to the code repository 435 to obtain executable program code 403 that takes the time zone offset into account when it is executed by the secure client 415.

In another example, the customer system 110 includes applications that are associated with licenses. Over time, information associated with the licenses may change. In some instances, because the customer system 110 includes out of date information associated with the licenses, the customer system 110 may determine that a license is expiring when it is not (e.g., a false positive identification of an expiration). In this example, the request 301 includes a request to clean out expired licenses as well as a date/time for executing the expired license clean out. In this example, the broker system 420/320 receives the request 301 and transmits it to the analysis system 439/339. The analysis system 439/339 generates a set of queries (e.g., including query 302) that includes a query (e.g., query 402) to a license manager system that includes updated license information. The license manager system provides information to the broker system 420 responsive to the query and the broker system 420 includes the information in a query to the code repository 435/335 to obtain executable program code 403 that takes the updated license information into account when the license clean out process is performed when the program code 403 is executed by the secure client 415.

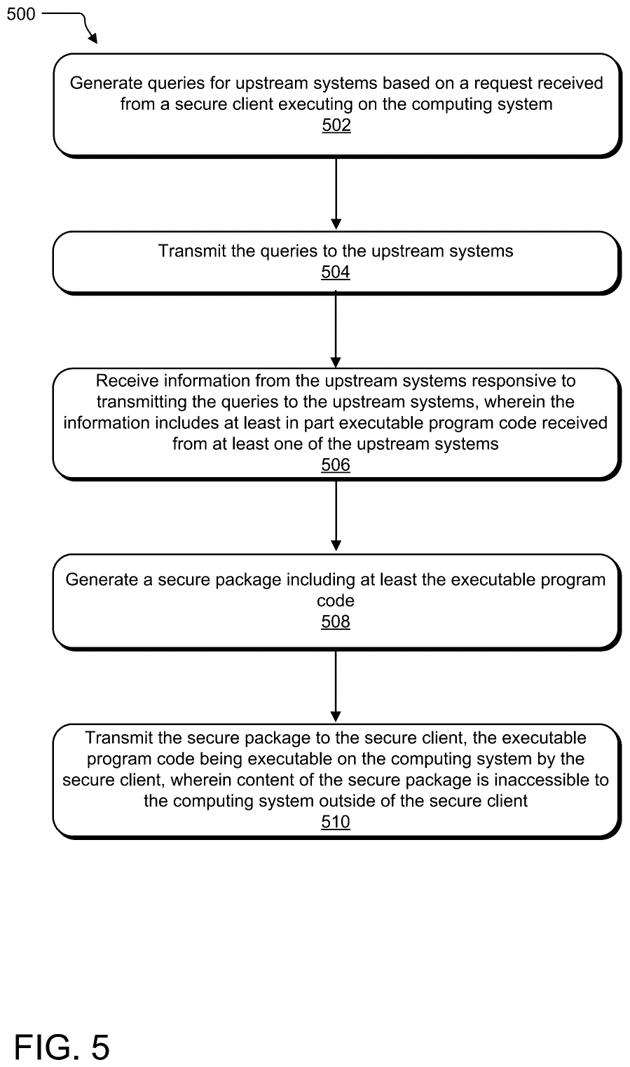

FIG. 5 depicts an example method 500 for providing executable code for a client to execute on a computing system. The example method 500 can be performed, in some implementations, by a broker system. Aspects of the method 500 not specifically described with respect to FIG. 5 may be the same or similar to other implementations described herein.

Example operation 502 involves an operation to generate queries for upstream systems based on a request received from a secure client executing on the computing system. For example, the computing system is a customer system and the secure client is a secure application executing on the customer system that communicates with the broker system via a network. In some instances, the request includes a request to perform a process that involves interacting with multiple upstream systems. In some instances, the request identifies a problem or issue with the computing system. In some implementations, generating the queries for the at least one upstream system includes transmitting the request to an analysis system and receiving, from the analysis system, the queries where each of the queries is associated with the respective upstream system. In these implementations, the analysis system generates the queries based on the request. For example, the analysis system determines that information from one or more specific upstream systems is necessary to receive (and/or generate) program code that is executable by the computing system to perform the process associated with the request. In these implementations, the analysis system transmits each query of the received queries to its associated upstream system.

Example operation 504 involves an operation to transmit the queries to the upstream systems.

Example operation 506 involves an operation to receive information from the upstream systems responsive to transmitting the queries to the upstream systems, wherein the information includes at least in part executable program code received from the at least one of the upstream systems. For example, information necessary to compile and/or generate program code that is executable by the computing system to perform the process associated with the request. In some instances, portions of program code are received from multiple upstream systems. In some instances, information is received from the at least one upstream system, and the operation 506 further includes transmitting a further query including at least a portion of the information to a code repository and receiving program code from the code repository responsive to the further query.

Example operation 508 involves an operation to generate a secure package including at least the executable program code. In some instances, the information received from the at least one upstream system includes the program code and the broker system extracts or otherwise determines the program code based on the received information. In some instances, the operation 508 involves generating the secure package based on the information received from the at least one upstream system. For example, the broker system generates a secure package that includes the program code and transmits the secure package to the secure client. The contents of the secure package (e.g., including the program code) are not accessible to the customer system outside of the secure client.

Example operation 510 involves an operation to transmit the secure package to the secure client, the executable program code being executable on the computing system by the secure client, wherein content to the secure package is inaccessible to the computing system outside of the secure client. For example, the secure client executes the program code on the computing system to cause the computing system to perform the process that is requested in the initial request provided by the secure client to the broker system or to perform a process that addresses an issue identified in the initial request provided by the secure client. In some instances, the process involves communicating with one or more upstream systems.

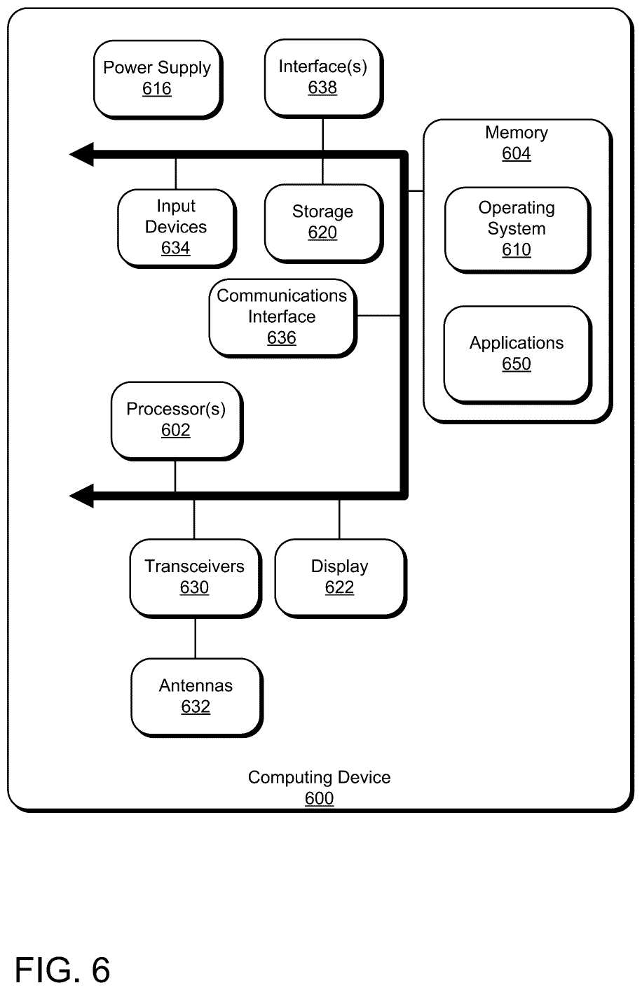

FIG. 6 illustrates an example computing device 600 for use in implementing the described technology. The computing device 600 may be a customer computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more software modules, segments, and/or processors, such as applications 650, a customer system, a secure client, a broker system, a query generator, an executable code generator, upstream systems, an analysis system, a scheduling system, a ticketing system, a state repository system, a code repository system, and other program code and modules are loaded into the operating system 610 on the memory 604 and/or the storage 620 and executed by the processor(s) 602. The storage 620 may store control data (information received from upstream systems, programming code) and other data and be local to the computing device 600 or may be remote and communicatively connected to the computing device 600. In one implementation, components of a system for classifying a dataset may be implemented entirely in hardware or in a combination of hardware circuitry and software.

The computing device 600 includes a power supply 616, which may include or be connected to one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of providing a program code to a secure client executing on a computing system, comprising: generating one or more queries for upstream systems based on a request received from the secure client executing on the computing system; transmitting the one or more queries to the upstream systems; receiving information from the upstream systems responsive to transmitting the one or more queries to the upstream systems, wherein the information includes at least in part executable program code received from at least one of the upstream systems; generating a secure package including at least the executable program code; and transmitting the secure package to the secure client, the executable program code being executable on the computing system by the secure client, wherein content of the secure package is inaccessible to the computing system outside of the secure client.

Clause 2. The method of clause 1, wherein the request identifies a process, the executable program code being executable by the secure client on the computing system to perform the process.

Clause 3. The method of clause 1, further comprising modifying the executable program code based on at least a portion of the information, wherein the secure package includes the modified executable program code, wherein the modified executable program code is executable on the computing system by the secure client.

Clause 4. The method of clause 1, the executable program code being executable on the computing system by the secure client to perform a process with the upstream systems.

Clause 5. The method of clause 1, the executable program code being executable on the computing system by the secure client to provide, on the computing system outside of the secure client, results of a process.

Clause 6. The method of clause 1, wherein generating the one or more queries comprises: transmitting the request to an analysis system of the upstream systems; and receiving, from the analysis system, the one or more queries, wherein the one or more queries are configured to request the information from the upstream systems.

Clause 7. The method of clause 1, further comprising: generating, based on the information, a second query to a ticketing system of the upstream systems; transmitting the second query to a ticketing system; receiving, from the ticketing system, a ticket number; and modifying the executable program code based on the ticket number, wherein the secure package includes the modified executable program code, wherein the modified executable program code is executable on the computing system by the secure client.

Clause 8. The method of clause 1, further comprising: generating, based on the information, a second query to a state repository system of the upstream systems; transmitting the second query to the state repository system; receiving, from the state repository system, second information different from the information; and modifying the executable program code based on the second information, wherein the secure package includes the modified executable program code, wherein the modified executable program code is executable on the computing system by the secure client.

Clause 9. The method of clause 1, the information comprising a program code identifier, and further comprising: generating a subsequent query to a program code repository system, the subsequent query comprising the program code identifier; and receiving, from the program code repository system, the program code responsive to transmitting the subsequent query.

Clause 10. The method of clause 1, wherein content of the secure package is accessible to the secure client in a transient memory.

Clause 11. The method of clause 10, wherein the executable program code is accessible to the secure client in the transient memory as a function of one or more of key values or variables.

Clause 12. A broker system for providing executable program code to a secure client, wherein the secure client is executable on a computing system, comprising: one or more hardware processors; a query generator executable by one or more hardware processors and configured to generate one or more queries for upstream systems based on a request received from the secure client executing on the computing system, transmit the one or more queries to the upstream systems; a communication interface executable by one or more hardware processors and configured to receive information from the upstream systems responsive to transmitting the one or more queries to the upstream systems, wherein the information includes at least in part executable program code received from at least one of the upstream systems; and a secure package generator executable by one or more hardware processors and configured to generate a secure package including at least the executable program code, the communication interface being further configured to transmit the secure package to the secure client, the executable program code being executable on the computing system by the secure client, wherein content of the secure package is inaccessible to the computing system outside of the secure client.

Clause 13. The broker system of clause 12, wherein the secure package generator is further configured to configure the secure package such that the executable program code is stored in a transient memory inaccessible to the computing system outside of the secure client.

Clause 14. The broker system of clause 12, wherein the request identifies a process, the executable program code being executable by the secure client on the computing system to perform the process.

Clause 15. The broker system of clause 12, the secure package generator being further configured to modify the executable program code based on at least a portion of the information, wherein the secure package includes the modified executable program code, wherein the modified executable program code is executable on the computing system by the secure client.

Clause 16. The broker system of clause 12, the executable program code being executable on the computing system by the secure client to perform a process with the upstream systems.

Clause 17. The broker system of clause 12, the executable program code being executable on the computing system by the secure client to provide, on the computing system outside of the secure client, results of a process.

Clause 18. The broker system of clause 12, wherein the query generator is configured to generate the one or more queries by: transmitting the request to an analysis system of the upstream systems; and receiving, from the analysis system, the one or more queries, wherein the one or more queries are configured to request the information from the upstream systems.

Clause 19. The broker system of clause 12, wherein the query generator is further configured to generate, based on the information, a second query to a ticketing system of the upstream systems, transmit the second query to a ticketing system and receive a ticket number from the ticketing system, and wherein the secure package generator is further configured to modify the executable program code based on the ticket number, wherein the secure package includes the modified executable program code, wherein the modified executable program code is executable on the computing system by the secure client.

Clause 20. The broker system of clause 12, wherein the query generator is further configured to generate, based on the information, a second query to a state repository system of the upstream systems, transmit the second query to the state repository system, and receive second information different from the information from the state repository system, and wherein the secure package generator is further configured to modify the executable program code based on the second information, wherein the secure package includes the modified executable program code, wherein the modified executable program code is executable on the computing system by the secure client.

Clause 21. The broker system of clause 12, wherein the query generator is further configured to generate a subsequent query to a program code repository system, the subsequent query comprising a program code identifier, wherein the secure package generator is further configured to receive, from the code repository system, the program code responsive to transmitting the subsequent query.

Clause 22. One or more tangible processor-readable storage media embodied with instructions for executing on one or more processors and circuits of a broker system a process for providing a program code to a client operating on a computing system, the process comprising: generating one or more queries for upstream systems based on a request received from a secure client executing on the computing system; transmitting the one or more queries to the upstream systems; receiving information from the upstream systems responsive to transmitting the one or more queries to the upstream systems, wherein the information includes at least in part executable program code received from at least one of the upstream systems; generating a secure package including at least the executable program code; and transmitting the secure package to the client, the executable program code being executable on the computing system by the secure client, wherein content of the secure package is inaccessible to the computing system outside of the secure client.

Clause 23. The one or more tangible processor-readable storage media of clause 22, wherein the request identifies a process, the executable program code being executable by the secure client on the computing system to perform the process.

Clause 24. The one or more tangible processor-readable storage media of clause 22, the process further comprising modifying the executable program code based on at least a portion of the information, wherein the secure package includes the modified executable program code, wherein the modified executable program code is executable on the computing system by the secure client.

Clause 25. The one or more tangible processor-readable storage media of clause 22, the executable program code being executable on the computing system by the secure client to perform a process with the upstream systems.

Clause 26. The one or more tangible processor-readable storage media of clause 22, the executable program code being executable on the computing system by the client to provide, on the computing system outside of the secure client, results of a process.

Clause 27. The one or more tangible processor-readable storage media of clause 22, wherein generating the query comprises: transmitting the request to an analysis system of the upstream systems; and receiving, from the analysis system, the at least one query being configured to request the information from the at least one upstream system.

Clause 28. The one or more tangible processor-readable storage media of clause 22, the process further comprising: generating, based on the information, a second query to a ticketing system of the upstream systems; transmitting the second query to a ticketing system; receiving, from the ticketing system, a ticket number; and modifying the executable program code based on the ticket number, wherein the secure package includes the modified executable program code, wherein the modified executable program code is executable on the computing system by the secure client.

Clause 29. The one or more tangible processor-readable storage media of clause 22, the process further comprising: generating, based on the information, a second query to a state repository system of the upstream systems; transmitting the second query to the state repository system; receiving, from the state repository system, second information different from the information; and modifying the executable program code based on the second information, wherein the secure package includes the modified executable program code, wherein the modified executable program code is executable on the computing system by the secure client.

Clause 30. The one or more tangible processor-readable storage media of clause 22, the information comprising a program code identifier, the process further comprising: generating a subsequent query to a program code repository system, the subsequent query comprising the program code identifier; and receiving, from the program code repository system, the program code responsive to transmitting the subsequent query.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, programming code, code segments, programming code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of providing a program code to a secure client executing on a computing system, comprising:
generating one or more queries for upstream systems based on a request received from the secure client executing on the computing system;
transmitting the one or more queries to the upstream systems;
receiving information from the upstream systems responsive to transmitting the one or more queries to the upstream systems, wherein the information includes at least in part executable program code received from at least one of the upstream systems;
generating a secure package including at least the executable program code; and
transmitting the secure package to the secure client, the executable program code being executable on the computing system by the secure client, wherein content of the secure package is inaccessible to the computing system outside of the secure client.

2. The method of claim 1, wherein the request identifies a process, the executable program code being executable by the secure client on the computing system to perform the process.

3. The method of claim 1, further comprising modifying the executable program code based on at least a portion of the information, wherein the secure package includes the modified executable program code, wherein the modified executable program code is executable on the computing system by the secure client.

4. The method of claim 1, the executable program code being executable on the computing system by the secure client to perform a process with the upstream systems.

5. The method of claim 1, the executable program code being executable on the computing system by the secure client to provide, on the computing system outside of the secure client, results of a process.

6. The method of claim 1, wherein generating the one or more queries comprises:
transmitting the request to an analysis system of the upstream systems; and
receiving, from the analysis system, the one or more queries, wherein the one or more queries are configured to request the information from the upstream systems.

7. The method of claim 1, further comprising:
generating, based on the information, a second query to a ticketing system of the upstream systems;
transmitting the second query to a ticketing system;
receiving, from the ticketing system, a ticket number; and
modifying the executable program code based on the ticket number, wherein the secure package includes the modified executable program code, wherein the modified executable program code is executable on the computing system by the secure client.

8. The method of claim 1, further comprising:
generating, based on the information, a second query to a state repository system of the upstream systems;
transmitting the second query to the state repository system;
receiving, from the state repository system, second information different from the information; and
modifying the executable program code based on the second information, wherein the secure package includes the modified executable program code, wherein the modified executable program code is executable on the computing system by the secure client.

9. The method of claim 1, the information comprising a program code identifier, and further comprising:
generating a subsequent query to a program code repository system, the subsequent query comprising the program code identifier; and
receiving, from the program code repository system, the program code responsive to transmitting the subsequent query.

10. The method of claim 1, wherein content of the secure package is accessible to the secure client in a transient memory.

11. The method of claim 10, wherein the executable program code is accessible to the secure client in the transient memory as a function of one or more of key values or variables.

12. A broker system for providing executable program code to a secure client, wherein the secure client is executable on a computing system, comprising:
one or more hardware processors;
a query generator executable by one or more hardware processors and configured to generate one or more queries for upstream systems based on a request received from the secure client executing on the computing system, transmit the one or more queries to the upstream systems;
a communication interface executable by one or more hardware processors and configured to receive information from the upstream systems responsive to transmitting the one or more queries to the upstream systems, wherein the information includes at least in part executable program code received from at least one of the upstream systems; and
a secure package generator executable by one or more hardware processors and configured to generate a secure package including at least the executable program code, the communication interface being further configured to transmit the secure package to the secure client, the executable program code being executable on the computing system by the secure client, wherein content of the secure package is inaccessible to the computing system outside of the secure client.

13. The broker system of claim 12, wherein the secure package generator is further configured to configure the secure package such that the executable program code is stored in a transient memory inaccessible to the computing system outside of the secure client.

14. The broker system of claim 12, wherein the request identifies a process, the executable program code being executable by the secure client on the computing system to perform the process.

15. The broker system of claim 12, the secure package generator being further configured to modify the executable program code based on at least a portion of the information, wherein the secure package includes the modified executable program code, wherein the modified executable program code is executable on the computing system by the secure client.

16. The broker system of claim 12, the executable program code being executable on the computing system by the secure client to perform a process with the upstream systems.

17. The broker system of claim 12, the executable program code being executable on the computing system by the secure client to provide, on the computing system outside of the secure client, results of a process.

18. The broker system of claim 12, wherein the query generator is configured to generate the one or more queries by:
transmitting the request to an analysis system of the upstream systems; and
receiving, from the analysis system, the one or more queries, wherein the one or more queries are configured to request the information from the upstream systems.

19. The broker system of claim 12, wherein the query generator is further configured to generate, based on the information, a second query to a ticketing system of the upstream systems, transmit the second query to a ticketing system and receive a ticket number from the ticketing system, and wherein the secure package generator is further configured to modify the executable program code based on the ticket number, wherein the secure package includes the modified executable program code, wherein the modified executable program code is executable on the computing system by the secure client.

20. The broker system of claim 12, wherein the query generator is further configured to generate, based on the information, a second query to a state repository system of the upstream systems, transmit the second query to the state repository system, and receive second information different from the information from the state repository system, and wherein the secure package generator is further configured to modify the executable program code based on the second information, wherein the secure package includes the modified executable program code, wherein the modified executable program code is executable on the computing system by the secure client.

21. The broker system of claim 12, wherein the query generator is further configured to generate a subsequent query to a program code repository system, the subsequent query comprising a program code identifier, wherein the secure package generator is further configured to receive, from the code repository system, the program code responsive to transmitting the subsequent query.

22. One or more tangible processor-readable storage media embodied with instructions for executing on one or more processors and circuits of a broker system a process for providing a program code to a client operating on a computing system, the process comprising:
generating one or more queries for upstream systems based on a request received from a secure client executing on the computing system;
transmitting the one or more queries to the upstream systems;
receiving information from the upstream systems responsive to transmitting the one or more queries to the upstream systems, wherein the information includes at least in part executable program code received from at least one of the upstream systems;
generating a secure package including at least the executable program code; and
transmitting the secure package to the client, the executable program code being executable on the computing system by the secure client, wherein content of the secure package is inaccessible to the computing system outside of the secure client.

23. The one or more tangible processor-readable storage media of claim 22, wherein the request identifies a process, the executable program code being executable by the secure client on the computing system to perform the process.

24. The one or more tangible processor-readable storage media of claim 22, the process further comprising modifying the executable program code based on at least a portion of the information, wherein the secure package includes the modified executable program code, wherein the modified executable program code is executable on the computing system by the secure client.

25. The one or more tangible processor-readable storage media of claim 22, the executable program code being executable on the computing system by the secure client to perform a process with the upstream systems.

26. The one or more tangible processor-readable storage media of claim 22, the executable program code being executable on the computing system by the client to provide, on the computing system outside of the secure client, results of a process.

27. The one or more tangible processor-readable storage media of claim 22, wherein generating the query comprises:
transmitting the request to an analysis system of the upstream systems; and
receiving, from the analysis system, the at least one query being configured to request the information from the at least one upstream system.

28. The one or more tangible processor-readable storage media of claim 22, the process further comprising:
generating, based on the information, a second query to a ticketing system of the upstream systems;
transmitting the second query to a ticketing system;
receiving, from the ticketing system, a ticket number; and
modifying the executable program code based on the ticket number, wherein the secure package includes the modified executable program code, wherein the modified executable program code is executable on the computing system by the secure client.

29. The one or more tangible processor-readable storage media of claim 22, the process further comprising:
generating, based on the information, a second query to a state repository system of the upstream systems;
transmitting the second query to the state repository system;
receiving, from the state repository system, second information different from the information; and
modifying the executable program code based on the second information, wherein the secure package includes the modified executable program code, wherein the modified executable program code is executable on the computing system by the secure client.

30. The one or more tangible processor-readable storage media of claim 22, the information comprising a program code identifier, the process further comprising:
generating a subsequent query to a program code repository system, the subsequent query comprising the program code identifier; and
receiving, from the program code repository system, the program code responsive to transmitting the subsequent query.
